(19) United States
(12) Patent Application Publication
(10) Pub. No.: US 2016/0337300 A1
(43) Pub. Date: Nov. 17, 2016

(54) COMMUNICATION ITEM INSIGHTS

(71) Applicant: Microsoft Technology Licensing, LLC, Redmond, WA (US)

(72) Inventors: Yoav Ossia, Haifa (IL); Jenny Feldman, Haifa (IL)

(21) Appl. No.: 14/712,613

(22) Filed: May 14, 2015

(51) Int. Cl. H04L 12/58

(52) U.S. Cl. CPC H04L 51/26; H04L 51/043; H04L 51/24

(57) ABSTRACT

A user may send and/or receive communication items through a communication service that includes an insight module configured to provide insights for the communication items, where the insights may help the user to prioritize handling of large numbers of communication items. For example, the insight module may be configured to determine one of a necessity to “reply”, “read”, and “ping” insight for a communication item based on a modeled history of past communication items associated with the user that include a similar set of attributes, with same or conflicting attribute values, to the communication item. The insight module may also be configured to determine one of a “needed,” “recommended,” and “possible” insight category based on a level of confidence that the communication item corresponds to the insight. The insight and insight category may then be displayed in association with the communication item through a user experience of the communication service.

### BACKGROUND

A communication service may enable a user to send and/or receive communication items including email messages, appointments, tasks, voicemail, and/or any other type of electronic event through various modules associated with the communication service. A large number of communication items may be received, for example, if the user is out of the office for an extended time period. The large number of communication items may potentially overwhelm the user, as it may be time-consuming to read and/or reply to each of the communication items. Furthermore, some of the communication items may be time-sensitive and/or of higher priority, needing more attention than other communication items.

In a conventional communication service, various rules may be applied to incoming communication items in an attempt to proactively handle a large volume communication items. For example, the communication items may be filtered based on rules defined by a user. However, the application of these rules may require manual maintenance by the user, may not be adaptive, and may not be accurate, often causing the communication items to be over-filtered. Accordingly, automatic and adaptive solutions for prioritizing the handling of communication items may be desired.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to provision of communication item insights. One or more attributes of a communication item associated with a user may be determined. An insight for the communication item may be determined based on a history of past communication items associated with the user, that include similar attributes to the determined attributes, and an insight category may be determined based on a level of confidence that the communication item corresponds to the insight. The insight and the insight category may then be displayed in association with the communication item through a communication application user experience.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes an example network environment where communication item insights may be provided;

FIG. 2 includes a conceptual diagram illustrating a two-phase process to provide communication item insights;

FIGS. 3A-3C illustrate various example configurations of a command bar associated with a communication application user experience;

FIG. 4 illustrates an example communication application user experience displaying various insights and insight categories determined for communication items in a collapsed categories' view;

FIGS. 5A and 5B illustrate two example configurations of a communication application user experience displaying communication item “reply” insights in an expanded categories' view;

FIGS. 6A and 6B illustrate two example configurations of a communication application user experience displaying communication item “ping” insights in an “inbox” folder and in a categories' view;

FIG. 7 illustrates an example communication application user experience, where insight suggestions may be displayed based on an insight model and determined attributes of acommunication item;

FIG. 8 is a block diagram of an example general purpose computing device, which may be used to provide communication item insights; and

FIG. 9 illustrates a logic flow diagram of a method to provide communication item insights, according to embodiments.

### DETAILED DESCRIPTION

As briefly described above, a communication service may enable a user to send and/or receive communication items including email messages, appointments, tasks, voicemail, and/or any other type of electronic event through various modules associated with the communication service. According to embodiments, the communication service may also include an insight module configured to provide insights for the sent and/or received communication items. The insight module may be configured to determine one or more attributes of a communication item associated with a user, and determine an insight for the communication item based on a modeled history of past communication items associated with the user that include a similar set of attributes, where values of the attributes of the past communication items may be the same or different from values of the attributes of the communication item. In some examples, if the communication item is a received communication item, one of a “reply” related insight and a “read” related insight may be determined, and if the communication item is a sent communication item that includes an attribute of age (that is, an attribute indicating a time elapsed from when the communication item was sent) without a response from a recipient, a “ping” related insight may be determined. The insight module may further be configured to determine an insight category based on a level of confidence that the communication item corresponds to the insight, where the insight category may be one of “needed,” “recommended,” and “possible.” For example, the “ping” related insight and an insight category may be combined to tag a sent communication item as “ping needed”, “ping recommended”, “ping possible”, or leave the communication item untagged (that is, no “ping” related insight is perceived for the communication item). The insight and insight category may then be displayed in association with the communication item through a user experience of the communication service, where the displayed insights may help the user to prioritize handling of a large number of communication items. In some embodiments, the communication items may be viewed in a chronological order by date sent and/or received. In other embodiments, the communication items may be grouped and displayed in a categorized matter based on insight and insight category.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for provision of communication item insights. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

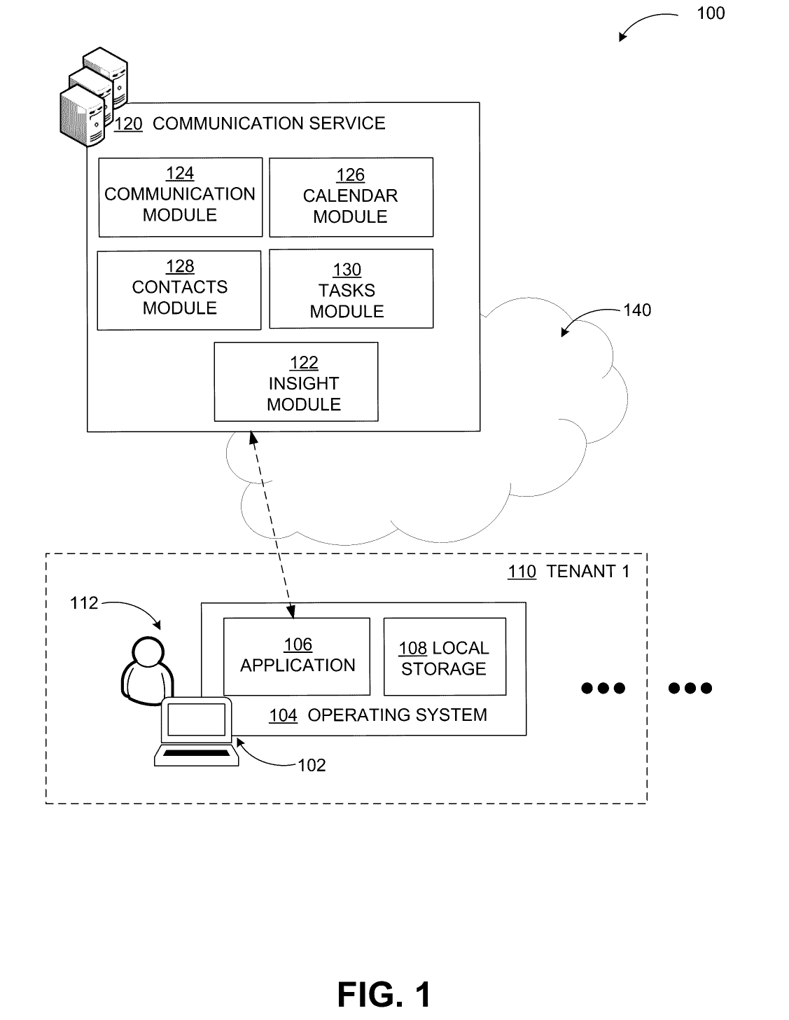

FIG. 1 includes an example network environment where communication item insights may be provided. As illustrated in diagram 100, one or more servers may provide a communication service 120 to a plurality of clients or tenants, where each tenant may provide access to the communication service 120 to one or more users.

On the user side, a user 112 may execute a thin (e.g., a web browser) or a thick (e.g., a locally installed client application) application 106 within an operating system 104 of their computing device 102 and access the communication service over one or more networks such as network 140. The computing device 102 may include a desktop computer, a laptop computer, a tablet computer, a vehicle mount computer, a smart phone, or a wearable computing device, among other similar devices. User 112 may be an example user under a tenant 110. As discussed above, any number of users within the infrastructure of any tenant may access the services of the communication service 120. User 112 may store content, such as communication items, associated with the communication service 120 locally at local storage 108 or remotely at data stores managed by the communication service 120 or by third party services.

The communication service 120 may include various modules configured to facilitate transmission and/or receipt of communication items, such as a communication module 124, a calendar module 126, a contacts module 128, and a tasks module 130, for example. The communication service 120 may also include an insight module 122 configured to provide insights for the communication items. The above-described modules of the communication service 120 may be implemented as software, hardware, or combinations thereof.

In an example embodiment, the communication module 124 may be configured to facilitate receipt of a communication item associated with the user 112, such as an email message. Other examples of communication items may include, an appointment, a task, a voicemail, and/or any other type of electronic event. The insight module 122 may be configured to use one or more attributes of the email message, such as a sender, one or more recipients, key words in a subject, a number of key words in the subject, a size of the subject, key words in a body, a number of key words in the body, a size of the body, and/or a number of attachments associated with the email message, for example. The insight module 122 may be configured to determine an insight for the email message based on values of the used attributes and a history of past email messages associated with the user 112 that include similar attributes and a known value of the insight (as the past email messages may be mature enough to include evidence of actual realization of a given insight). The determined insight for the received email message may indicate a necessity of “read”, and/or “reply”. The “read” insight may indicate the user 112 should probably read the received email message, and the “reply” insight may indicate the user 112 should probably reply to the received email message. In other examples, if the email message was a communication item sent by the user 112, the determined insight may include a “ping” insight. The “ping” insight may indicate that the email message sent by the user is likely to have been replied to by now, by one or more recipients, but no recipient has replied yet. The “ping” insight may be used as a notification, for example, to advise the user 112 to get in touch with the recipients and remind them to respond to the email message.

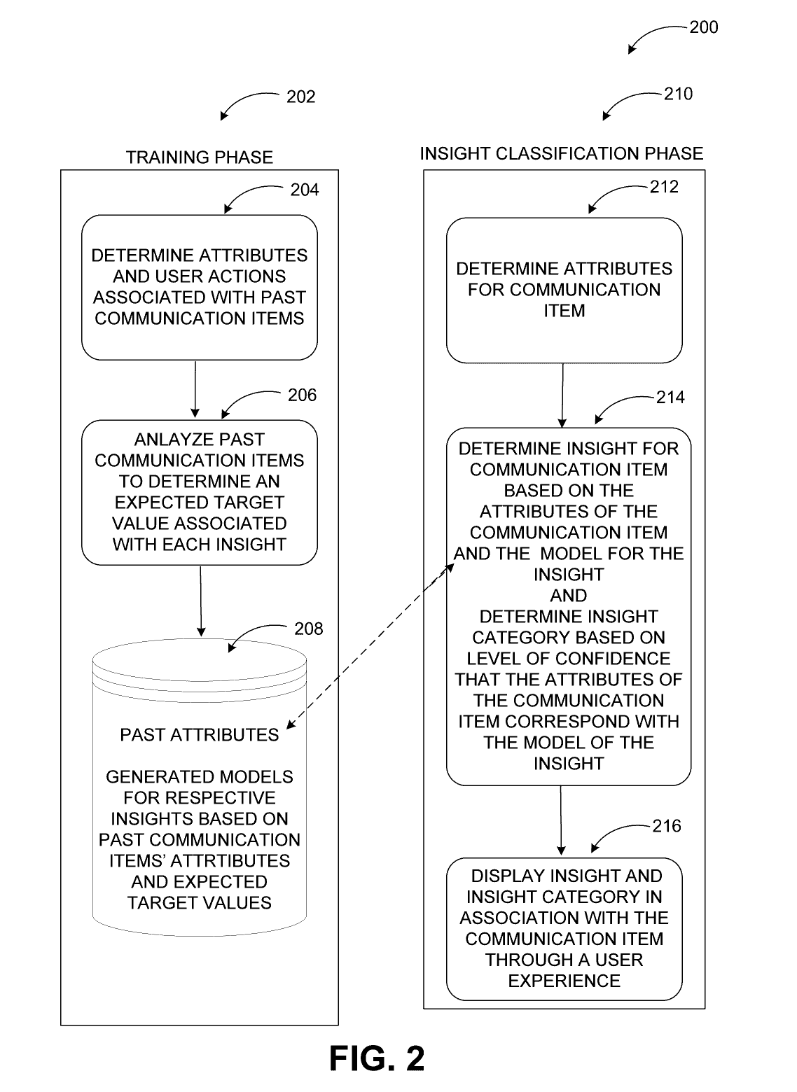

To determine the insight for the email message based on the history of past email messages, the insight module 122 may generate, for each insight, a machine learning model that is based on attributes and user actions associated with the past communication items. These attributes and user actions may also derive an actual value of the insight per each “mature” past communication item. The insight module 122 may compare the attributes of the model to the attributes of the email message and calculate a value of the insight (or an absence of the insight) for the email message. For example, if attributes of the “reply” model (that is, attributes associated with past communication items to which the user 112 replied) correlate with the attributes of the email message, a “reply” insight may be determined. Alternatively, if the attributes of the “reply” model contradict (or are different from) the attributes of the email message, or the attributes of the “reply” model that most closely match the attributes of the email message are for past email messages which were not replied to, no “reply” insight may be suggested. The generation of these insight-specific models will be discussed in more detail in conjunction with FIG. 2.

The insight module 122 may also be configured to determine an insight category based on a level of confidence that the email message corresponds to the insight model, where the insight category includes “needed”, “recommended”, or “possible”, among other examples of confidence level category. For example, if a number of the attributes of the email message similar to the attributes of the “reply” model (that is, for past email messages that were indeed replied) is above one or more thresholds, the insight module 122 may determine that there is a high level of confidence that the user 112 will likely reply to the email, and determine the insight category to be “needed.” The insight module 122 may then be configured to display the insight and insight category in association with the email message through a user experience associated with the communication service 120. For example, the insight module 122 may display “reply needed” in association with the email message. In some embodiments, the email message may be viewed among other email messages in a chronological order by date sent and/or received. In other embodiments, the email message may be grouped and displayed with other email messages having a same insight and insight category. The insight and the insight category for the communication item may be removed from display in response to a determination that an action associated with the insight has been completed. For example, in response to a determination that the user 112 has replied to a communication item with a determined “reply” insight, the associated insight and insight category may be removed from display.

As previously discussed, in a conventional communication service, various rules may be applied to communication items in an attempt to handle the receipt of communication items, where the communication items may be filtered based on user defined rules, for example. However, the application of these rules may require manual maintenance by a user (which may be time consuming and tedious), may not be adaptive, and may be unreliable, often causing the communication items to be over-filtered.

According to the embodiments described herein, the insight module may automatically determine insight and insight categories as communication items are sent and/or received, such that no manual maintenance by the user is needed. Therefore, if a large number of communication items are received by the user, the user may simply view the determined insight and insight categories displayed through the user experience in association with the communication items to efficiently prioritize which communication items should be read and replied to first, for example. In some embodiments, the communication items may be grouped and displayed by insight and insight category to further aid the user in prioritization. The insight module 122 may be also configured to determine a “ping” insight. The “ping” insight may be determined for a communication item if the communication item is a sent communication item that includes a first attribute associated with an age of the communication item (that is, a time elapsed from when the communication item was sent), a second attribute associated with whether the communication was responded to with a negative value (that is, a “was responded to” attribute with a negative value), and the past communication items, used for the “ping” insight model, also includes these attributes, plus the time it took the item to be responded (if there was a response). Display of the “ping” insight may remind the sender of the email that they may need to contact the recipient to invoke a response and/or reply to the communication item. The insight module 122 may be further configured to provide suggestions to a sender of a communication item based on a determined insight for the communication item, where the suggestion may increase a probability that one or more recipients may read and/or reply to the communication item according to the insight. As such, provision of communication item insights may greatly increase user interactivity and improve usability.

Determination of an insight value for a communication item, including “no match for this insight”, may be based on a level of correlation with a respective insight model generated based on a history or characteristics of past communication items. The past communication items may include similar attributes to the attributes of the communication item for which the insight is requested, as well as an indication of the actual value for the insight because the past communication items are mature items, whose attributes are no longer expected to change over time. Such insight models may be generated by any machine-learning technique. For example, the insight models may be Decision Tree models based on a collection of items with attributes, where one or more of the attributes are target attributes and the model is built for a specific value of the target attributes. The machine-learning technique for generating the insight models may also provide a means for generating a probability for a new communication item to have a target value for the insight. For example, in Decision tree model, the probability of a yet-unknown target attribute to be of the target value. Additionally, the insight module 122 may be configured to periodically re-generate the insight models to adapt to current patterns of user actions associated with the past communication items. In some embodiments, if a history of past communication items associated with the user doesn't exist and/or is limited, attributes and user actions associated with past communication items of other users (similar to the user) may be used to determine the insight. As such, the determination of insight based on communication attributes and a known past history of communication items (whether it may be associated with user or other users similar to the user) may enhance reliability and accuracy.

Embodiments address a need that arises from very large scale of operations created by networked computing and cloud based services that cannot be managed by humans. The actions/operations described herein are not a mere use of a computer, but address results of a system that is a direct consequence of software used as a service such as the communication service 120 offered in conjunction with large numbers of extensions.

FIG. 2 includes a conceptual diagram illustrating a process to provide communication item insights. A communication service may enable users to send and/or receive communication items including email messages, appointments, tasks, voicemail, and/or any other type of electronic event through various modules associated with the communication service. The communication service may also include an insight module configured to provide communication item insights.

As illustrated in diagram 200, the insight module may be configured to provide communication item insights by executing two phases, a training phase 202 and an insight classification phase 210. The training phase 202 may be executed periodically, in response to a user request received through a communication service user experience, and/or each time the insight module is activated in order to generate insights. In the training phase 202, the insight module may be configured to determine attributes and user actions associated with past communication items of a user 204. The past communication items, for example, may be communication items sent and/or received by the user within the past 3 months, excluding the past week, where the communication items from the past week may be excluded due to these items being immature and as such, a target value of the insight (calculated from one or more of the attributes of the past communication items) is not yet known to be final, or not known yet at all.

The attributes of the past communication items may include a sender, recipients, key words in a subject, a number of key words in the subject, a size of a subject, key words in a body, a number of key words in the body, a size of the body, and/or a number of attachments, for example. Furthermore, the attributes may be associated with “hot” and “cold” values. “Hot” values may correspond to values that are common enough in past communication items where the insight target value is positive, and “cold” values may correspond to values that are common enough in past communication items where the insight target value is negative. For example, a frequency histogram for all occurrences of values in past communication items may be maintained for each attribute, and a set of most frequently occurring values, up to a determined threshold, may be selected. Then, each past communication item may be appended with additional Boolean attributes, such as “includes hot/cold” keywords in subject, “includes hot/cold” keywords in body, “includes hot/cold” senders, and/or “includes hot/cold” recipients. Similar Boolean attributes may be calculated for the determined attributes of the current received and/or sent communication item, and serve like any other attribute. Furthermore, the hot/cold attributes may not be used only as Boolean values, but also as numeric attributes. For example, a number of hot/cold keywords in subject. As such additional attributes of the communication past communication items may include hot/cold senders, hot/cold receivers, hot/cold keywords in a subject, a number of hot/cold keywords in a subject, hot/cold keywords in a body, a number of hot/cold keywords in a body, and/or any other attributes that may have a diversity of values.

The user actions associated with the past communication items may include whether the user read and/or replied to the past communication items, and whether the past communication items sent by the user were replied to by one or more recipients. The user actions on past communication items may inform an insight of “read”, “reply”, or “ping”, respectively. In some examples, timing associated with the user actions may also be determined. For example, how long it took the user to reply to the past communication items, or how long it took others to reply to the user's sent communication items.

In some embodiments, a history of past communication items associated with the user may not exist and/or may be limited. For example, if the user is a new employee, a limited number of communication items may have been sent and/or received by the user, and thus a limited number of attributes and user actions may be available. In such embodiments, attributes and actions associated with past communication items of other users may be determined. For example, a history of past communication items associated with various other employees in a same department, and a similar position to the user may be determined. In further embodiments, the attributes and actions associated with past communication items of the other users may be determined in conjunction with the attributes and actions associated with past communication items of the user to broaden an analysis pool, even when the history of past communication items associated with the user may not be limited.

For each insight, the attributes and user actions of the past communication items may be analyzed (phase 206) in order to determine an expected target value associated with a respective insight. For example, the attributes and user actions of the past communication items may be fed into a Decision Tree model (or graph) with the already known value associated with the respective insight in order to generate a model. In other examples, machine learning techniques other than a Decision Tree may be employed. A separate model for each insight may be generated and stored along with a list of the attributes in a repository 208, such as a data store associated with the communication service. The insight module may be configured to periodically re-generate the models to adapt to current patterns of user actions associated with the past communication items. In some embodiments, the models may be persisted with a same server configured to host the communication service.

In one embodiment, the insight classification phase 210 may be executed automatically. For example, the insight module may determine one or more attributes of a communication item 212 as it is sent or received employing the list of attributes stored in the repository. Accordingly, the attributes of the communication item may include a sender, one or more recipients, key words in a subject, a number of key words in the subject, a size of the subject, key words in a body, a number of key words in the body, a size of the body, and/or a number of attachments, for example. Attributes that may have a diversity of values may be configured into a reduced attribute format in a similar manner as previously described in conjunction with the “hot” and “cold” values.

The insight module may be configured to determine an insight for the communication item based on a history of the past communication items, and determine an insight category based on a level of confidence that the communication item corresponds to the insight 214. For example, the insight module may apply each of the insight-specific models to the attributes of the communication item in order to determine the insight of the communication item. In an example scenario, if the “ping” insight model comprises attributes that best match the attributes of the communication item, the determined insight may be “ping.” A probability of the communication item corresponding to the insight may be determined based on a number of attributes of the communication item that match the attributes of the insight-specific model. For example, if using a Decision Tree, the Decision Tree graph may be traversed according to the match between the attributes of the communication item and the attributes and values of the graph's nodes, where a leaf node's value may be used as the calculated probability. As an alternative and simpler example, if 5 out of 10 attributes of the communication item match attributes of the insight-specific model, the communication item may have a 50% probability of corresponding to the insight. The level of confidence used to determine the insight category may be based on the probability, where the insight category may be one of “needed,” “recommended,” and “possible.” In some embodiments, various thresholds may be defined in association with the probability to determine the level of confidence, where a first threshold may be set at 30% probability and a second threshold may be set at 60% probability, for example. Accordingly, a probability below the first threshold indicates a low level of confidence (or “possible” insight category), a probability between the first and second threshold indicates a medium level of confidence (or “recommended” insight category), and a probability above the second threshold indicates a high level of confidence (or “needed” insight category).

In another embodiment, the insight classification phase 210 may be executed in response to a user request received through the communication service user experience, where the user request may specify an insight and a time period. For example, if the user has been out of office for the past 4 days and has limited time to read through all the received communication items, the user may specify the past 4 days as the time period and request a “reply” insight to determine the communication items that the user will likely reply to. Accordingly, attributes of the communication items received in the past 4 days may be determined employing the list of attributes from the repository, and an insight category for each communication item may be determined based on a level of confidence that the respective communication item corresponds to the “reply” insight, in a similar manner as described above. In other examples, the user request specify an insight and a communication item. Similarly, attributes of the specified communication item may be determined employing the list of attributes from the repository, and an insight category for the communication item may be determined based on a level of confidence that the specified communication item corresponds to the specified insight.

The insight module may then be configured to display the insight and the insight category in association with the communication item through the user experience of the communication service 216. In some examples, an order in which the communication item is displayed among other communication items may be by date. Alternatively, the communication item may be grouped and displayed with other communication items having a same insight and insight category. In some examples, the insight and the insight category may be attached to the communication item. The insight and the insight category for the communication item may be removed from display in response to a determination that an action associated with the insight has been completed. For example, in response to a determination that the user has read a communication item with a determined “read” insight, the associated insight and insight category may be removed from display.

In other embodiments, the insight module may be further configured to display one or more suggestions to a user who is sending a communication item in order to increase a likelihood that a recipient responds. For example, if the anticipated insight for the communication item about to be sent is “ping,” the insight module may suggest to change one or more of the attributes that currently increase the likelihood of a “ping” insight in order to decrease “need ping” likelihood, or in other words increase the chances that this communication item will be responded to by the recipient quickly, once sent. In some embodiments, the insight module may also provide a list of suggested attributes to include based on the attributes of the past communication items, such as “hot” subject keywords, where the list may be provided to the user through a link to the repository storing the attributes of the past communication items.

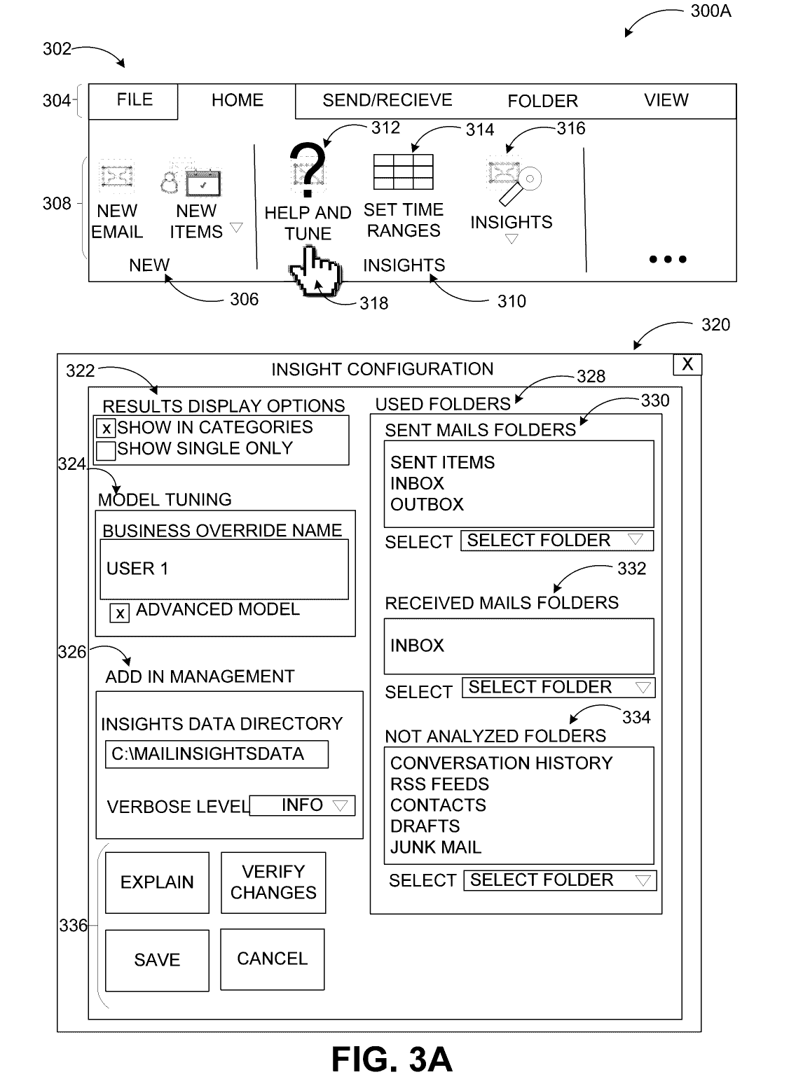

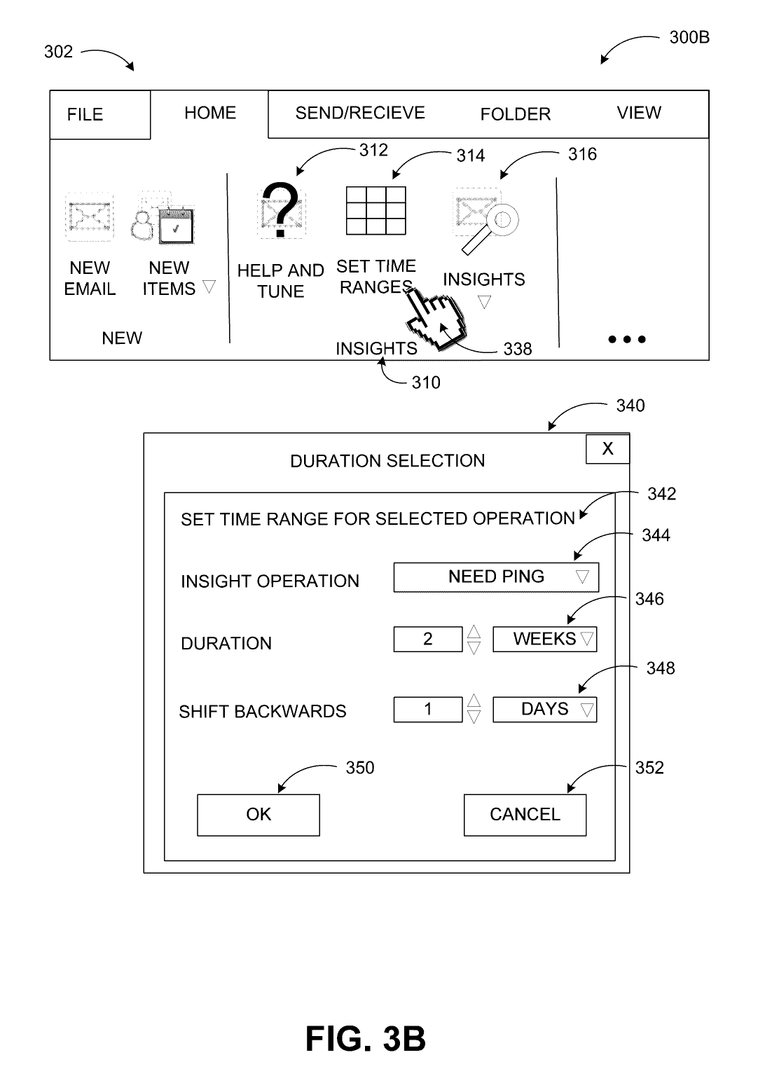

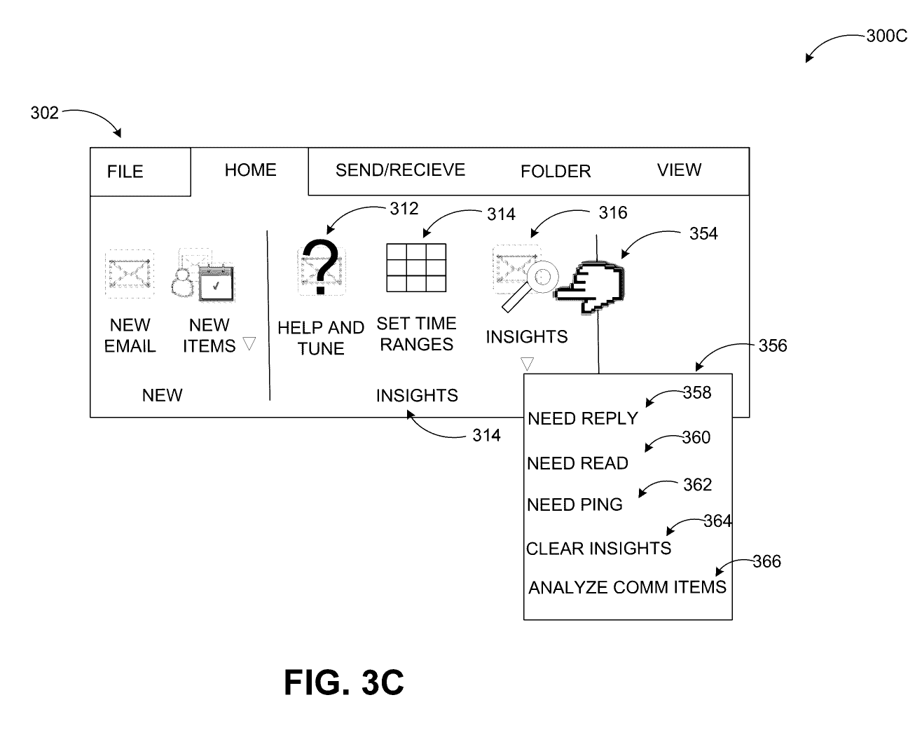

FIGS. 3A-3C illustrate various example configurations of a command bar associated with a communication service user experience.

As shown in diagram 300A, a communication service user experience may include a command bar 302 to enable user interactivity with the communication service. The command bar 302 may employ a textual scheme, a graphical scheme, an audio scheme, an animation scheme, a coloring scheme, a highlighting scheme, and/or a shading scheme, among other schemes, to enhance presentation to the user. The command bar 302 may include one or more tabs 304, such as a file tab, a home tab, a send/receive tab, a folder tab, and a view tab, among other examples. Each of the tabs 304 may include one or more groups, such as a new group, a delete group, and a response group, comprising graphical control elements that enable the user to perform various actions associated with one or more modules of the communication service. Example actions may include to create new communications, delete communications, and/or respond to communications, respectively. In some examples, the graphical control elements may be associated with icons and/or text-based labels, where the labels may indicate an action associated with the graphical control element.

The home tab may include a new group 306 and an insights group 310, among other groups. The new group 306 may include graphical control elements 308 that enable the user to create and send communication items through one of a communication module, calendar module, task module, and contact module of the communication service. The communication items may include email messages, appointments, tasks, voicemail, and/or any other type of electronic event, for example. The insights group 310 may include other graphical control elements (e.g., 312, 314, and 316) that enable the user to provide communication item insights through an insight module of the communication service.

A first graphical control element 312 displayed within the insights group 310, may be associated with an action that provides instructional help and enables tuning (or configuration) of the insight determination process. In response to a user actuation 318 of the first graphical control element 312, an insight configuration dialog box 320 may be accessed through an instructional dialog box provided to the user through the communication service user experience. The insight configuration dialog box 320 may enable the user to select various settings associated with the insight module. The user may be enabled to select how insight and insight categories are displayed 322 by the insight module. For example, a communication item may be grouped and displayed with other communication items having a same insight and insight category. The user may also be enabled to select how to tune an insight-specific model 324 and/or how to manage the insight module through the communication service 326.

The user may further be enabled to select which types of sent and/or received communication items (based on a folder in which the communication items are stored) may be analyzed by the insight module 328 to determine insights. For example, the user may select folders in three categories: folders for sent communication items 330, folders for received communication items 332, and not-analyzed folders 334. As illustrated, the user may indicate that insights may be determined for sent communication items residing in the sent items, inbox, and outbox folders (folders for sent communication items 330), and insights may be determined for received communication items within an inbox folder (folders for received communication items 332). Additionally, past communication items within these folders may be analyzed and used to generate models (applied by the insight module to determine insights). The user may indicate that insights may not be determined for communication items within not-analyzed folders 334, such as conversation history, rich site summary (RSS) feeds, contacts, drafts, and junk mail folders. As such, all communication items from the not-analyzed folders may be filtered out when generating the models. By excluding non-essential communication items from insight determination, such as “spam” mail, for example, the resulting model may be more accurate, a processor load associated with the insight module may be reduced, and a processing speed may be increased. The insight configuration dialog box 320 may also include various control elements 336 such as explain, verify changes, save (a new configuration), and cancel.

As shown in a diagram 300B, a second graphical control element 314 displayed within the insights group 310 of the home tab of the command bar 302, may be associated with an action to set a time range for an insight operation. In response to a user actuation 338 of the second graphical control element 314, a duration selection dialog box 340 may be presented to the user. The duration selection dialog box 340 may prompt 342 the user to “set a time range for a selected operation,” for example. The user may be enabled to select an insight operation 344, a duration 346, and a shift backwards 348. For example, the actual time range for the selected operation may end in the “shift backwards” time before the current time (when operation is executed) and start in the “Duration” time before the end time.

The selectable options for the insight operation 344 may include, “need ping”, “need reply”, “need read”, and “analyze communication items”, for example. As illustrated in diagram 300B, the user may select the “need ping” insight operation that upon execution may determine any sent communication item which has a sufficient probability to be replied at its current age (that is, the time from when the communication item was sent until current insight determination time), but is still without a response from any recipient of the communication item. The user may also select the duration 346, such as a number of days, weeks, and/or months in which to analyze the communication items for the selected insight operation. For example, as illustrated in diagram 300B, the user may select a duration of 2 weeks causing the insight module to determine any sent communication item from the past 2 weeks, which is likely to be already responded to in its current age, but is still without a response. The user may then further select the shift backwards 348, such as a number of days or weeks, which may shift the selected duration 346 back in time, relative to execution of the selected insight operation 344. For example, the user may select a shift backwards of 1 day causing the insight module to execute the same selected insight operation 344 operation, but on 2 weeks terminating yesterday. Once the user has selected the insight operation 344, the duration 346, and the shift backwards 348, the user may confirm their selections 350 and/or if the user decides to select other options or return to a previous duration selection, the user may select cancel 352.

As shown in diagram 300C, a third graphical control element 316 displayed within the insights group 310 of the home tab of the command bar 302, may be associated with actions associated with execution of one or more insights. In response to a user actuation 354 of the third graphical control element 316, a menu 356 comprising the insight actions, such as “need reply” 358, “need read” 360, “need ping” 362, “clear insights” 364, and “analyze communication items” 366 may be presented to the user. User selection of one of these actions may execute the respective action.

For example, if the user selects “need reply” 358, the insight module may be configured to determine communication items received within a period of time denoted by the duration, terminating in the shift backward time from present time, with a “reply” insight that may indicate necessity of the communication items to be replied to by the user. If the user selects “need read” 360 the insight module may be configured to determine communication items received within the given duration, terminating in the shift backward time from present time, with a “read” insight that may indicate a necessity of the communication items to be read by the user. If the user selects “need ping” 362, the insight module may be configured to determine communication items sent within the given duration, terminating in the shift backward time from present time, with a “ping” insight that may indicate the communication items that were likely to have been replied to by a recipient by now, but have not been replied to yet.

The insight module may then determine an insight category for each of the sent and/or received communication items with a determined insight based on a level of confidence that the respective communication item corresponds to the insight. The insight categories may include “needed,” “recommended,” and “possible.” The insight and respective insight category may be displayed in association with each of the communication items through the communication service user experience. In some embodiments, the displayed insights may serve as reminders and/or alerts for the user.

In other examples, if the user selects “clear insights” 364, the insight module may be configured to delete previously determined insights. If the user selects “analyze communication items” 366, the insight module may be configured to initiate re-training of the insight-specific models discussed previously in conjunction with FIG. 2.

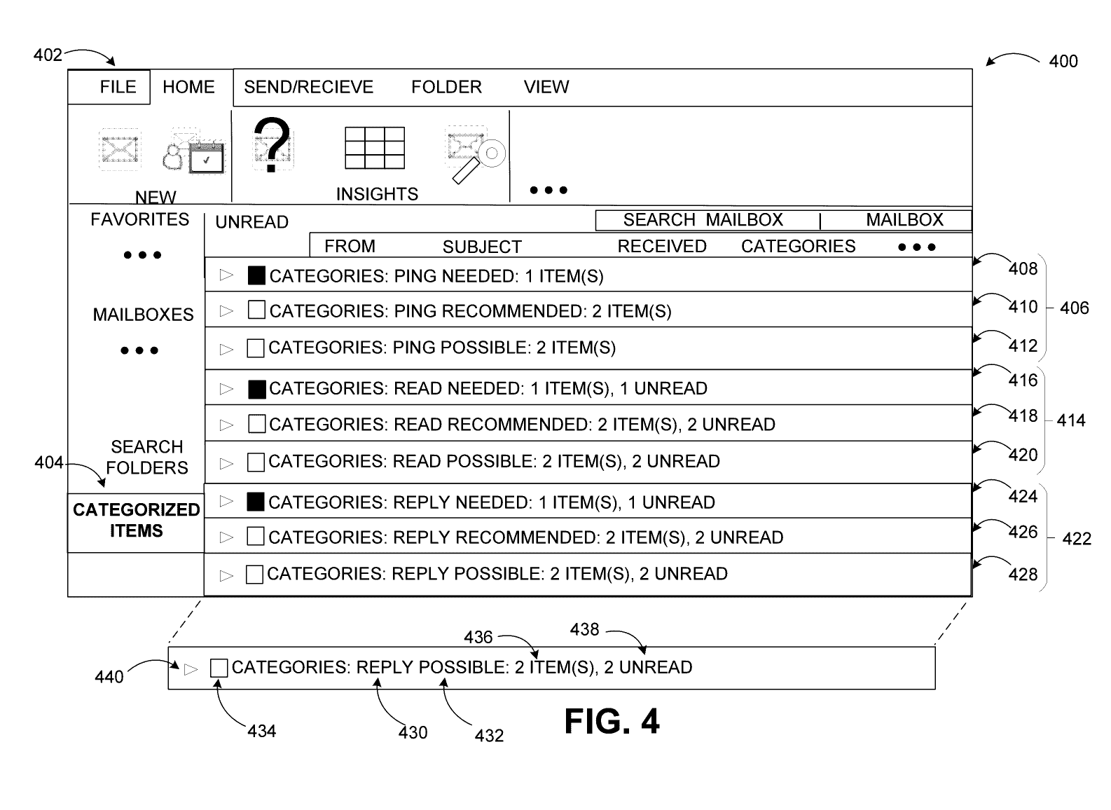

FIG. 4 illustrates an example communication service user experience displaying various insights and insight categories determined for communication items in a collapsed categories' view. A communication service may enable users to send and/or receive communication items including email messages, appointments, tasks, voicemail, and/or any other type of electronic event through various modules associated with the communication service. The communication service may also include an insight module configured to provide communication item insights. For example, the insight module may determine one or more attributes of a communication item associated with a user, determine an insight for the communication item based on a history of past communication items associated with the user that include similar attributes to the determined attributes, and determine an insight category based on a level of confidence that the communication item corresponds to the insight.

As shown in diagram 400, the user may select to view the communication items through a categorized items folder 404 (or view) of a communication service user experience 402 such that the communication items for which there are determined insights may be grouped and displayed in a categorized manner. According to embodiments, the communication items may be grouped into categories for display based on a determined insight, such as a “ping” insight 406, a “read” insight 414, and a “reply” insight 422. For example categories 408, 410, and 412 may include communication items with a determined “ping” 406 insight, categories 416, 418, and 420 may include communication items with a determined “read” insight 414, and categories 424, 426, and 428 may include communication items with a determined “reply” insight 422. Communications items may then be further grouped based on the determined insight category, where the insight category may be one of “needed”, “recommended”, or “possible.” For example, categories 408, 410, and 412 may include communication items with determined “ping needed”, “ping recommended”, and “ping possible,” insights, respectively. Categories 416, 418, and 420 may include communication items with determined “read needed”, “read recommended”, and “read possible,” insights, respectively. Categories 424, 426, and 428 may include communication items with determined “reply needed”, “reply recommended”, and “reply possible,” insights, respectively.

Each of the categories may textually display a determined insight 430 and insight category 432, in addition to an icon 434 displayed adjacent to the determined insight 430 and insight category 432. Each category may further include a textual indication of a number of communication items within the category 436 and how many of the communication items within the category have not been read 438. In some examples, the categories may be displayed in a collapsed view as illustrated. In other examples, the categories may be displayed in an expanded view such that the communication items are displayed underneath respective categories. A control element 440 may be selected by the user in order to display the categories and communication items in the expanded view.

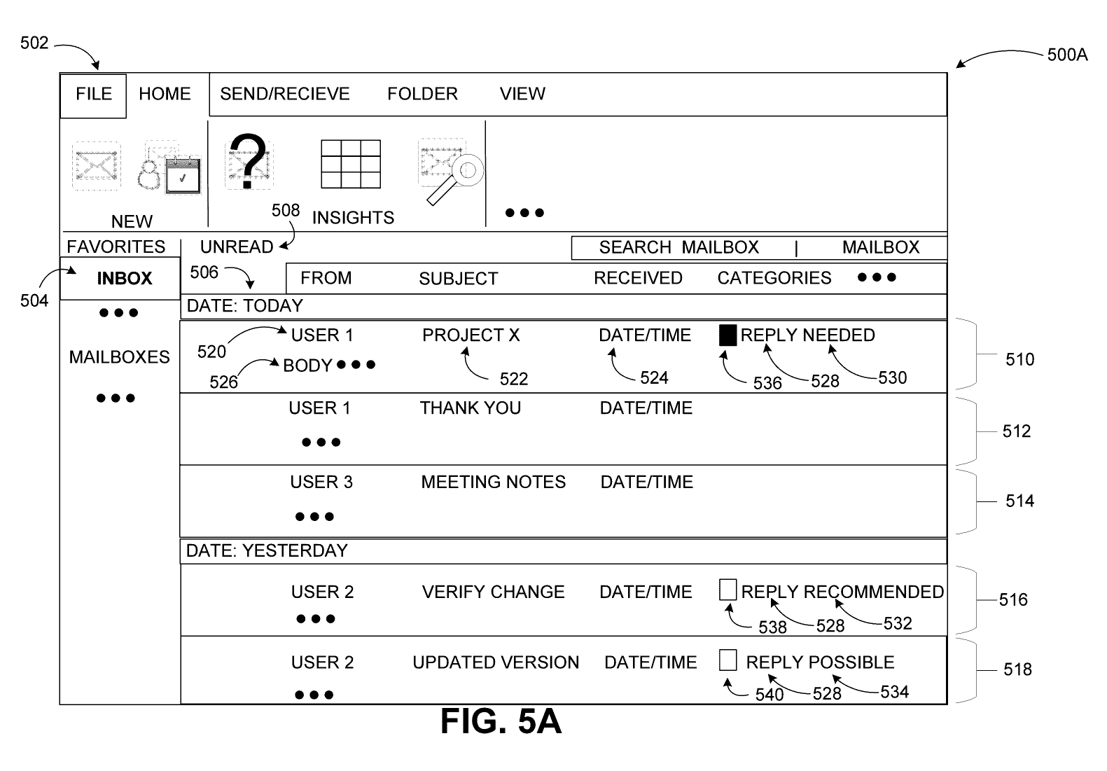

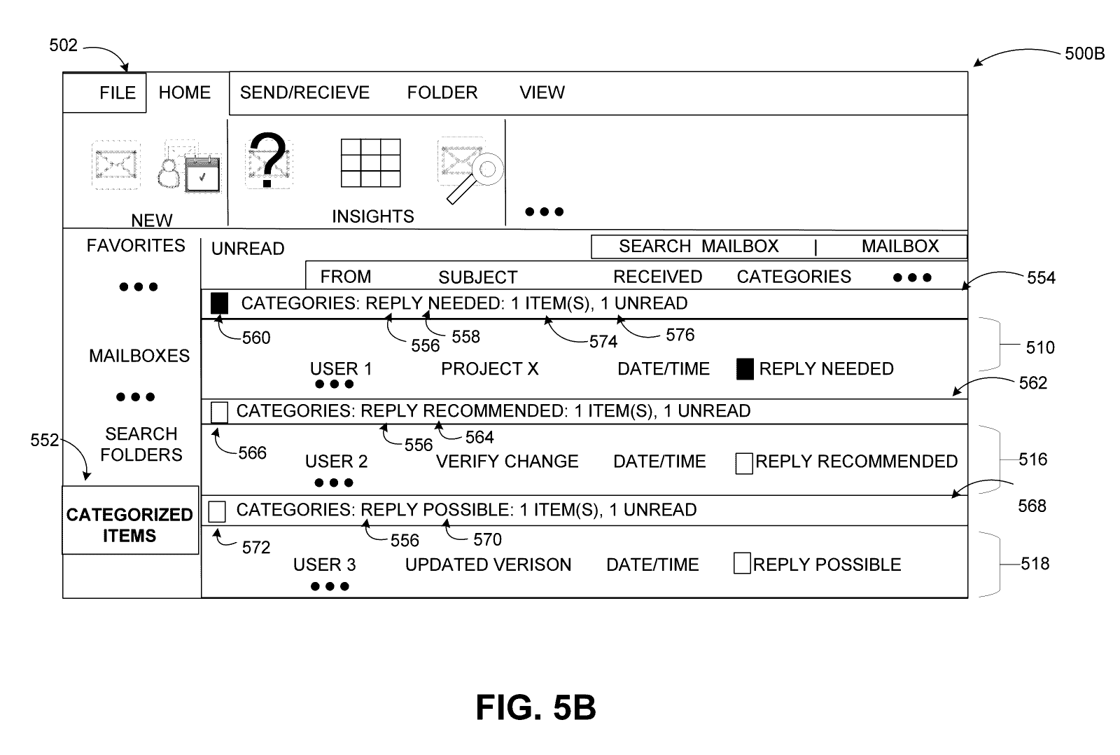

FIGS. 5A and 5B illustrate two example configurations of a communication service user experience displaying communication item “reply” insights in an expanded categories' view. A communication service may enable users to send and/or receive communication items, such as email messages. The communication service may also include an insight module configured to provide insights for the email messages. For example, the insight module may determine one or more attributes of a communication item associated with a user, determine an insight for the communication item based on a history of past communication items associated with the user that include similar attributes to the determined attributes, and determine an insight category based on a level of confidence that the communication item corresponds to the insight.

In a first configuration, the user may select to view received email messages through an inbox folder 504 of a communication service user experience 502, where the email messages may be displayed by date received 506, as illustrated in FIG. 5A, diagram 500A. Furthermore, the user may select to only view email messages that are unread 508 (e.g., email messages 510, 512, 514, 516, and 518). Each of the email messages may be displayed in the communication service user experience 502 such that a sender 520, a subject 522, a date and time received 524, and a portion of a body 526 is viewable by the user, for example. The insight module of the communication service may determine a “reply” insight for email messages that are likely to be replied to by the user, such as email messages 510, 516, and 518. The insight module may also determine an insight category for each of the email messages 510, 516, and 518 based on a level of confidence that the respective email message corresponds to the “reply” insight. The determined insight and respective insight category may be then be displayed in association with the email messages 510, 516, and 518 through the communication service user experience 502.

Display of the determined insight and insight categories may include a textual scheme, a graphical scheme, an audio scheme, an animation scheme, a coloring scheme, a highlighting scheme, and/or a shading scheme, among other schemes, to enhance presentation to the user. For example, a “reply” insight 528 and respective insight categories of “needed” 530, “recommended” 532, and “possible” 534 may be textually displayed in association with the email messages 510, 516, and 518. Icons 536, 538, and 540 may be displayed adjacent to the determined “reply” insight 528 and respective insight categories of “needed” 530, “recommended” 532, and “possible” 534. The icons 536, 538, and 540 may be different colors and/or shades. For example, the icon 536 associated with “reply needed” may be darkest in color and/or shade to indicate that the user is very likely to reply to the email message 510. Accordingly, the user may choose to reply to the email message 510 prior to other email messages 516 and 518 with a determined “reply recommended” or “reply possible” insight and insight category.

In a second configuration, the user may select to view the communication items through a categorized item folder 552 (or view) of the communication service user experience 502 such that email messages for which there are determined insights, such as email messages 510, 516, and 518, may be grouped and displayed by categories, as illustrated in FIG. 5B, diagram 500B. Each category 554, 562, and 568 may textually display a “reply” insight 556 and a respective insight category of “needed” 558, “recommended” 564, and “possible” 570. Each category 554, 562, and 568 may also include a respective icons 560, 566, and 572 displayed adjacent to the determined “reply” insight 556 and respective insight categories of “needed” 558, “recommended” 564, and “possible” 570. Each category 554, 562, and 568 may further include an indication of a number of communication items and/or emails within the category 574 and how many of the communication items and/or emails within the category have not been read 576. The email messages 510, 516, and 518 themselves may be displayed in a similar manner as described in FIG. 500A.

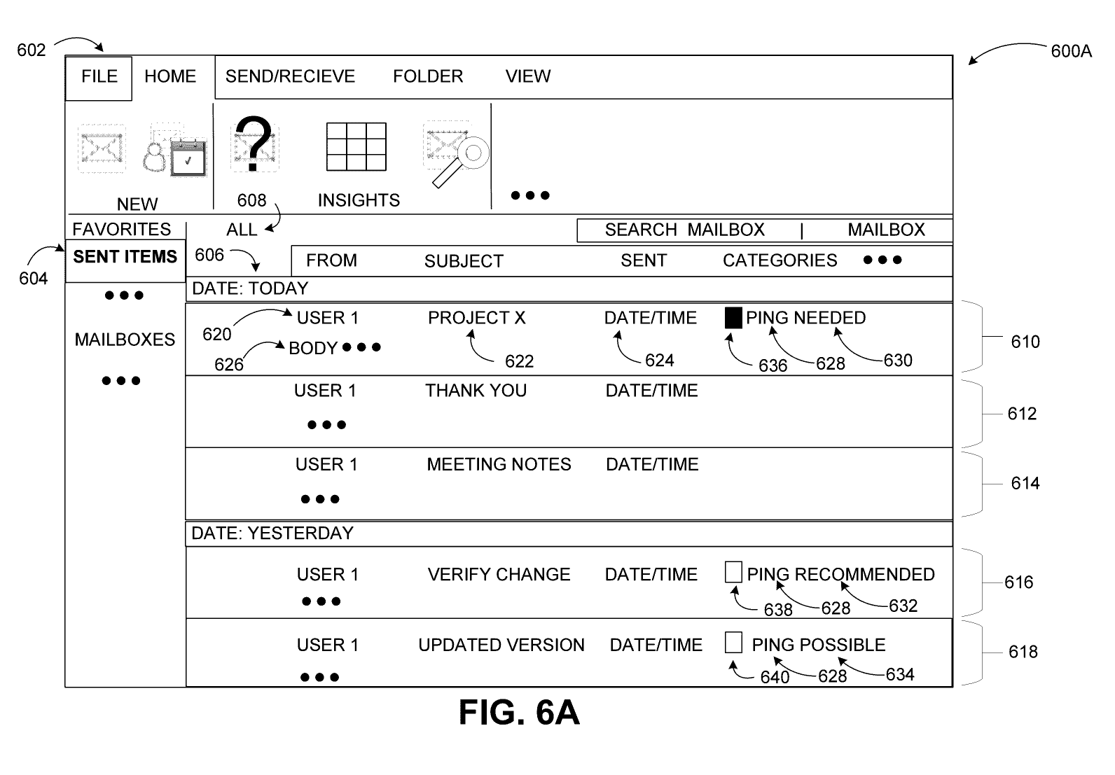

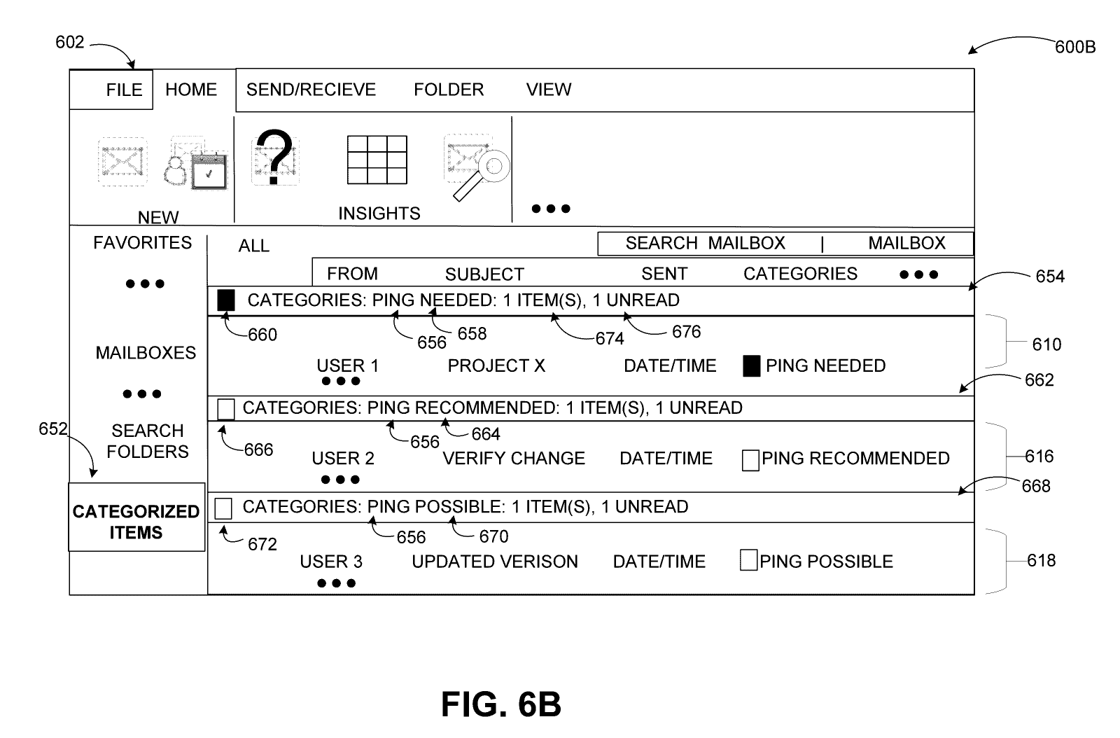

FIGS. 6A and 6B illustrate two example configurations of a communication application user experience displaying communication item “ping” insights in an “inbox” folder and in a categories' view. A communication service may enable users to send and/or receive communication items, such as email messages. The communication service may also include an insight module configured to provide insights for the email messages. For example, the insight module may determine one or more attributes of a communication item associated with a user, determine an insight for the communication item based on a history of past communication items associated with the user that include a similar set of attributes (with similar or conflicting attribute values) to the determined attributes, and determine an insight category based on a level of confidence that the communication item corresponds to the insight, as discussed in detail in conjunction with FIG. 2.

In a first configuration, the user may select to view all (608) sent email messages (e.g., email messages 610, 612, 614, 616, and 618) through a sent items folder 604 of a communication service user experience 602, where the email messages may be displayed by date sent 606, as illustrated in FIG. 6A, diagram 600A. Each of the email messages may be displayed in the communication service user experience 602 such that the sender 620 (in this case the user), a subject 622, a date and time sent 624, and a portion of a body 626 is viewable by the user, for example. The insight module of the communication service may determine a “ping” insight for email messages that were sent and have reached a sufficient age without a response from any recipient, such as email messages 610, 616, and 618. The insight module may also determine an insight category for each of the email messages 610, 616, and 618 based on a level of confidence that the respective email messages corresponds to the “ping” insight. The determined insight and respective insight category may be then be displayed in association with the email messages 610, 616, and 618 through the communication service user experience 602.

Display of the determined insight and insight categories may include a textual scheme, a graphical scheme, an audio scheme, an animation scheme, a coloring scheme, a highlighting scheme, and/or a shading scheme, among other schemes, to enhance presentation to the user. For example, a “ping” insight 628 and respective insight categories of “needed” 630, “recommended” 632, and “possible” 634 may be textually displayed in association with the email messages 610, 616, and 618. Icons 636, 638, and 640 may be displayed adjacent to the determined “ping” insight 628 and respective insight categories of “needed” 630, “recommended” 632, and “possible” 634. The icons 636, 638, and 640 may be different colors and/or shades. For example, the icon 636 associated with “ping needed” may be darkest in color and/or shade to indicate to the user a high importance that the user contact the recipient of the email message 610 to try to invoke a response from the recipient. In some embodiments, in response to a determination that the user has “pinged” and/or contact the recipient of the email message 610 to try to invoke a response from the recipient, the associated insight and insight category may be removed from display.

In a second configuration, the user may select to view the sent communication items through a categorized items folder 652 of the communication service user experience 602 such that email messages for which there are determined insights, such as email messages 610, 616, and 618, may be grouped and displayed by categories, as illustrated in FIG. 6B, diagram 600B. Each category 654, 662, and 668 may textually display a “ping” insight 656 and a respective insight category of “needed” 658, “recommended” 664, and “possible” 670. Each category 654, 662, and 668 may also include a respective icon 660, 666, and 672 displayed adjacent to the determined “ping” insight 656 and respective insight categories of “needed” 658, “recommended” 664, and “possible” 670. Each category 654, 662, and 668 may further include an indication of a number of communication items and/or emails within the category 674 and how many of the communication items and/or emails within the category have not been read 676. The email messages 610, 616, and 618 themselves may be displayed in a similar manner as described in FIG. 600A.

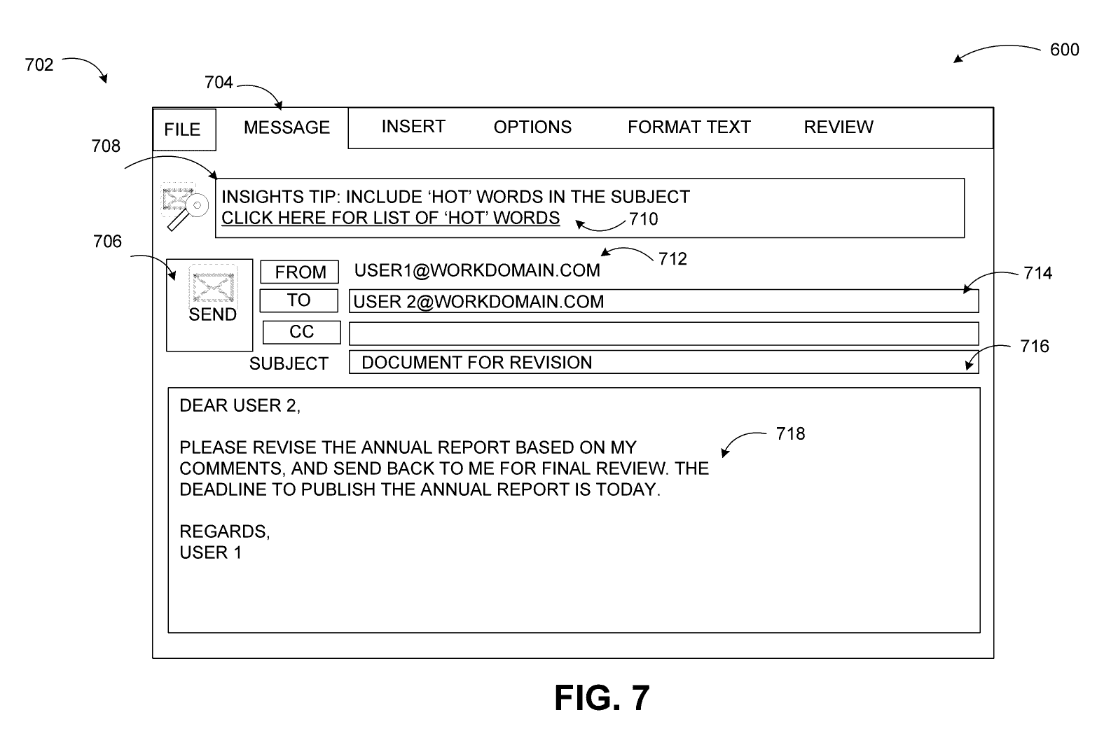

FIG. 7 illustrates an example communication application user experience, where suggestions may be provided based on an insight model and determined attributes of a communication item. As shown in diagram 700, a user may create an email message 704 to send 706 to one or more other users through a communication service user experience 702, where transmission of the email message may be facilitated by a communication module of a communication service. An insight module of the communication service may be configured to determine one or more attributes (denoted by 712 through 718) of the email message 704, such as a sender 712, a recipient 714, a size and/or key words of a subject 716, and a size and/or key words of a body 718 of the email message 704. The insight module may then be configured to determine an anticipated insight for the email message 704 based on past email messages. For example, in a training phase executed by the insight module, a model for each insight may be generated based on the respective insight and an expected target value associated with the respective insight. The expected target value may be based on attributes and user actions associated with of the past communication items. Accordingly, the insight module may apply the insight-specific models, such as the “ping” insight model, to determine which of the attributes of the email message 704 may be modified to decrease the probability for “need ping” insight, while increasing the probability that the item will be replied. In an example scenario, the attributes of a “ping” insight model may correlate with one or more attributes of the email message 704, such as the subject 716. Accordingly, a suggestion 708 or insights tip may be displayed in conjunction with the email message 704 through the communication service user experience 702. For example, the suggestion 708 may include to add “hot” keywords to subject in order to decrease an anticipated probability of “need ping,” while increasing probability of receiving a response from the recipients. In some embodiments, the insight module may provide a list of suggested words to include based on the attributes of the past communication items, where the list may be provided through a link 710 to a repository storing the attributes of the past communication items.

The insight module may also be configured to determine an insight category based on a level of confidence that the email message 704 corresponds to the insight. For example, a probability of the email message 704 corresponding to the insight may be determined using a Decision Tree model, where the probability is determined by a leaf node reached when traversing the model's graph according to the attributes of the email message 704. Alternatively, the probability may be based on a number of attributes of the email message 704 that match the attributes of the insight-specific model, and the level of confidence may be based on the probability. Continuing the example scenario above, 4 out of 6 attributes of the email message 704, such as the sender 712, the recipient 714, the size of the body 718, and the key words in the body 718, may correlate with attributes of the “ping” insight model. Accordingly, 4 out of 6 attributes may be above a threshold, indicating a high level of confidence and an insight category of “needed.” In some embodiments, the insight category may also affect whether or not a suggestion, such as suggestion 708, is displayed.

The examples provided in FIGS. 1 through 7 are illustrated with specific services, modules, and user experience configurations. Embodiments are not limited to environments according to these examples. Provision of communication insights may be implemented in environments employing fewer or additional services, modules, and user experience configurations. Furthermore, the example services, modules, and user experience configurations shown in FIG. 1 through 7 may be implemented in a similar manner with other values using the principles described herein.

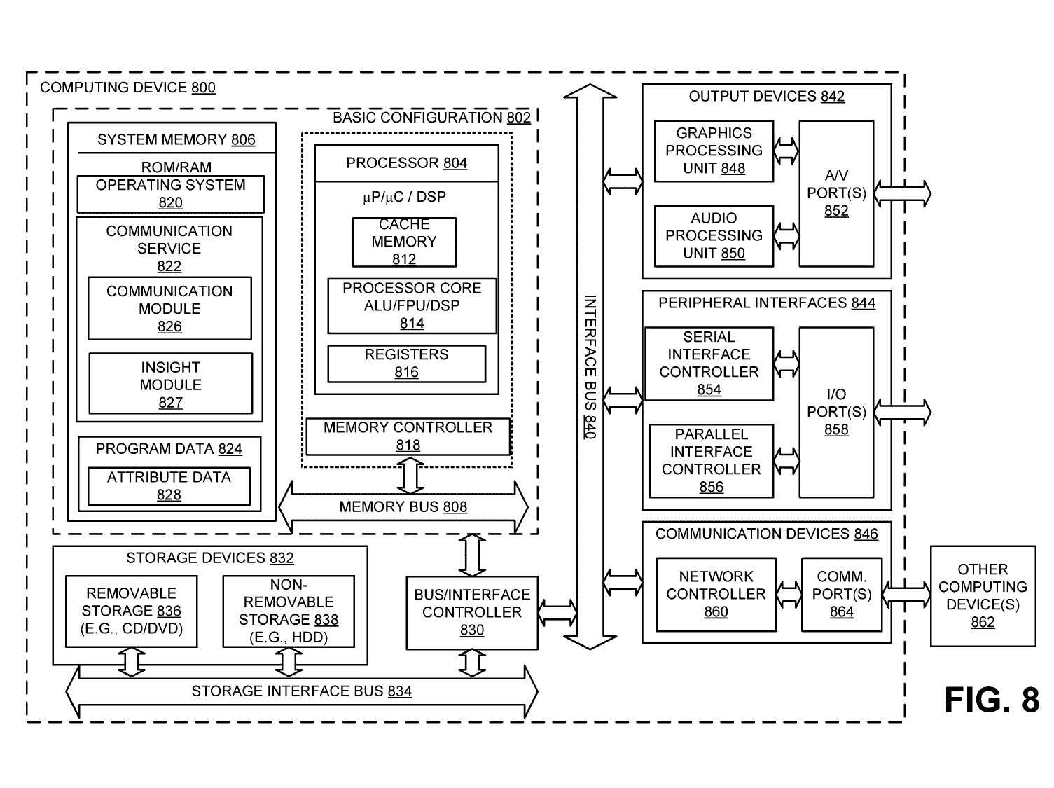

FIG. 8 and the associated discussion are intended to provide a brief, general description of a general purpose computing device, which may be used to provide communication item insights.

For example, computing device 800 may be used as a server, desktop computer, portable computer, smart phone, special purpose computer, or similar device. In an example basic configuration 802, the computing device 800 may include one or more processors 804 and a system memory 806. A memory bus 808 may be used for communicating between the processor 804 and the system memory 806. The basic configuration 802 is illustrated in FIG. 8 by those components within the inner dashed line.

Depending on the desired configuration, the processor 804 may be of any type, including but not limited to a microprocessor (μP), a microcontroller (μC), a digital signal processor (DSP), or any combination thereof. The processor 804 may include one more levels of caching, such as a level cache memory 812, one or more processor cores 814, and registers 816. The example processor cores 814 may (each) include an arithmetic logic unit (ALU), a floating point unit (FPU), a digital signal processing core (DSP Core), or any combination thereof. An example memory controller 818 may also be used with the processor 804, or in some implementations the memory controller 818 may be an internal part of the processor 804.

Depending on the desired configuration, the system memory 806 may be of any type including but not limited to volatile memory (such as RAM), non-volatile memory (such as ROM, flash memory, etc.) or any combination thereof. The system memory 806 may include an operating system 820, a communication service 822, and program data 824. The communication service 822 may include a communication module 826 and an insight module 827, which may be integrated modules of the communication service 822 or independent modules. The communication service may also include various other modules such as a calendar module, a task module, and a contacts module, among other examples. The communication module 826 may be configured to facilitate at least one of transmission and receipt of a communication item, and the insight module 827 may be configured to perform tasks associated with providing insights for the communication item, as described herein. The program data 824 may include, among other data, process data 828 related to attribute data, as described herein.

The computing device 800 may have additional features or functionality, and additional interfaces to facilitate communications between the basic configuration 802 and any desired devices and interfaces. For example, a bus/interface controller 830 may be used to facilitate communications between the basic configuration 802 and one or more data storage devices 832 via a storage interface bus 834. The data storage devices 832 may be one or more removable storage devices 836, one or more non-removable storage devices 838, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 806, the removable storage devices 836 and the non-removable storage devices 838 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 800. Any such computer storage media may be part of the computing device 800.

The computing device 800 may also include an interface bus 840 for facilitating communication from various interface devices (for example, one or more output devices 842, one or more peripheral interfaces 844, and one or more communication devices 846) to the basic configuration 802 via the bus/interface controller 830. Some of the example output devices 842 include a graphics processing unit 848 and an audio processing unit 850, which may be configured to communicate to various external devices such as a display or speakers via one or more A/V ports 852. One or more example peripheral interfaces 844 may include a serial interface controller 854 or a parallel interface controller 856, which may be configured to communicate with external devices such as input devices (for example, keyboard, mouse, pen, voice input device, touch input device, etc.) or other peripheral devices (for example, printer, scanner, etc.) via one or more I/O ports 858. An example communication device 846 includes a network controller 860, which may be arranged to facilitate communications with one or more other computing devices 862 over a network communication link via one or more communication ports 864. The one or more other computing devices 862 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 800 may be implemented as a part of a general purpose or specialized server, mainframe, or similar computer that includes any of the above functions. The computing device 800 may also be implemented as a personal computer including both laptop computer and non-laptop computer configurations.

Example embodiments may also include methods to provide communication item insights. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

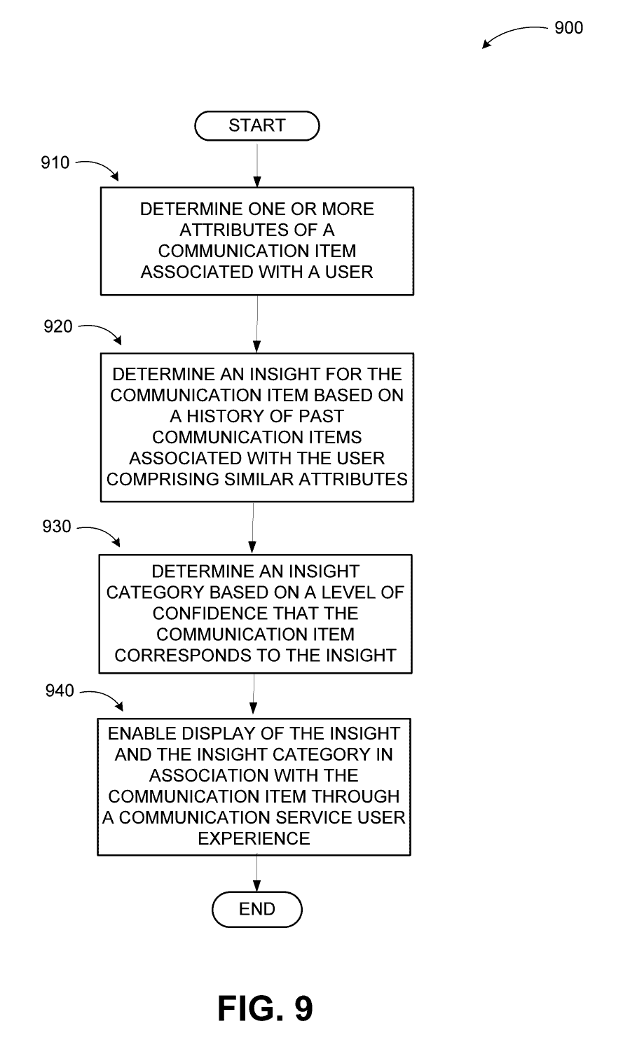

FIG. 9 illustrates a logic flow diagram for process 900 of a method to provide communication insights, according to embodiments. Process 900 may be implemented on a server or other system.

Process 900 begins with operation 910, where one or more attributes of a communication item associated with a user may be automatically determined by an insight module. In some embodiments, a specific set of attributes may be used for each insight to be determined for the communication item (that is certain attributes, for “read”, “reply” and “ping” insights). The attributes may include a sender, one or more recipients, key words in a subject, a number of key words in the subject, a size of the subject, key words in a body, a number of key words in the body, a size of the body, and/or a number of attachments, for example. In some embodiments, the attributes may more specifically include hot/cold recipients or senders, hot/cold key words in the subject, a number of hot/cold key words in the subject, hot/cold keywords in the body, and/or a number of hot/cold key words in the body. At least one of these attributes may be a target value for the insight. The insight module may be a module of a communication service comprising various other modules, such as a communication module, calendar module, task module, and contacts module, which may be configured to facilitate transmission and/or receipt of the communication item.

At operation 920, the insight module may be configured to determine the insight for the communication item based on a history of past communication items associated with the user that include similar attributes to the attributes determined in operation 910. For example, in a training phase executed by the insight module, a model for each insight may be generated based on the respective insight and an expected value associated with the respective insight, where the expected value may be based on attributes and user actions associated with of the past communication items. Accordingly, the insight module may apply the insight-specific models to determine which model's attributes most closely match the attributes of the communication item in order to determine the insight.

At operation 930, the insight module may be configured to determine an insight category based on a level of confidence that the communication item corresponds to the insight. In one example, a probability of the communication item corresponding to the insight may be determined based on correlation with a respective insight specific model (e.g., a Decision Tree graph) or based on a number of attributes of the communication item that match the attributes of the insight-specific model, and the level of confidence may be based on the probability.

At operation 940, the insight and the insight category may be displayed in association with the communication item through a user experience associated with the communication service. The communication item may be displayed chronologically with one or more other communication items by a date the communication item was sent and/or received. Alternatively, the communication item may be grouped and displayed with other communication items having a same insight and insight category. In further examples, the insight and the insight category may be attached to the communication item.

The operations included in process 900 are for illustration purposes. Provision of communication item insights may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

A means for providing communication item insights may include a means for determining one or more attributes of a communication item associated with a user, a means for determining an insight for the communication item based on a history of past communication items associated with the user that includes similar attributes to the determined attributes, a means for determining an insight category based on a level of confidence that the communication item corresponds to the insight, and a means for displaying the insight and the insight category in association with the communication item through a communication application user experience.

According to some examples, computing devices configured to provide a communication item insight are described. An example computing device may include a memory configured to store instructions, and one or more processors coupled to the memory that are configured to execute a communication service. The communication service may include a communication module and an insight module. The communication module may be configured to facilitate transmission and/or receipt of a communication item. The insight module may be configured to determine one or more attributes of the communication item associated with a user, determine an insight for the communication item based on a history of past communication items associated with the user comprising similar attributes to the determined attributes, determine an insight category based on a level of confidence that the communication item corresponds to the insight, and enable display of the insight and the insight category in association with the communication item through a user experience associated with the communication service.

In other examples, the insight may include “reply”, “ping”, or “read”. The insight category may include “needed”, “recommended”, or “possible”. The attributes of the communication item may include a sender, one or more recipients, key words in a subject, a number of key words in the subject, a size of the subject, key words in a body, number of key words in the body, a size of the body, and a number of attachments. The communication item may include an e-mail message, an appointment, a task, a voicemail, and/or an electronic event.

In further examples, if the communication item is a received communication item, a “reply” insight or a “read” insight may be determined. If the communication item is a sent communication item with a first attribute associated with an age of the sent communication item and a second attribute associated with whether the sent communication item was responded to by one or more recipients, a “ping” insight may be displayed.

According to some embodiments, methods executed at least in part on a computing device to provide a communication item insight maybe provided. An example method may include determining one or more attributes of a communication item associated with a user, and determining an insight for the communication item based on a history of past communication items associated with the user comprising similar attributes to the determined one or more attributes, where if the communication item is a received communication item, a “reply” insight or a “read” insight is determined, and if the communication item is a sent communication item with a first attribute associated with an age of the sent communication item and a second attribute associated with whether the sent communication item was responded to by one or more recipients, a “ping” insight is determined. The example method may further include determining an insight category based on a level of confidence that the communication item corresponds to the insight, and enabling display of the insight and the insight category in association with the communication item through a communication service user experience.

In other embodiments, a user request to determine the insight for the communication item may be received through the communication service user experience, wherein the user request includes an insight and at least one of a time period and a communication item. Determining the insight for the communication item based on the history of past communication items may include determining one or more attributes and one or more user actions associated with the past communication items, where the user actions inform an insight, determining an expected value associated with the insight based on the determined attributes of the past communication items; and generating a model based on the insight and the expected value, where a separate model is generated for the “read” insight, the “reply” insight, and the “ping” insight. The model may be applied to the determined one or more attributes of the communication item to determine the insight for the communication item. The model may be re-generated periodically to adapt to current patterns of user actions. The model may be persisted with a same entity configured to execute a communication service.

In further embodiments, determining the insight category based on the level of confidence that the communication item corresponds to the insight may include determining a probability of the communication item corresponding to the insight based on an applied model, and defining one or more thresholds in association with the probability in order to determine the level of confidence. At least one of the attributes of the communication item may be configured into a reduced attribute format by adding values of the at least one attribute to a frequency histogram, tagging frequently occurring values of the at least one attribute of the communication item, and generating the reduced attribute format based on a number of occurrences of the tagged values of the at least one attribute of the communication item.

According to some examples, computer readable memory devices with instructions stored thereon to provide a communication item insight may be described. Example instructions include determining one or more attributes of a communication item that comprises an e-mail message, an appointment, a task, a voicemail, and/or an electronic event associated with a user, and determining an insight for the communication item based on a history of past communication items associated with the user comprising similar attributes to the determined one or more attributes. The example instructions may further include determining an insight category based on a level of confidence that the communication item corresponds to the insight, and enabling display of the insight and the insight category in association with the communication item through a communication service user experience.

In other examples, if the communication item is a communication item to be sent, one or more suggestions based on the determined insight may be provided to a sender of the communication item through the communication service user experience, where implementation of the suggestions may increase a probability that one or more recipients of the communication item at read and/or reply to the communication item. The insight and the insight category for the communication item may be enabled to be removed from display in response to a determination that an action associated with the insight has been completed. The communication item may be grouped with one or more other communication items with a same insight and insight category for display through the communication service user experience.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device configured to provide a communication item insight, the computing device comprising:
a memory configured to store instructions; and
one or more processors coupled to the memory that are configured to execute a communication service, wherein the communication service comprises:
a communication module configured to facilitate at least one of transmission and receipt of a communication item; and
an insight module configured to:
determine one or more attributes of the communication item associated with a user;
determine an insight for the communication item based on a history of past communication items associated with the user comprising similar attributes to the determined one or more attributes;
determine an insight category based on a level of confidence that the communication item corresponds to the insight; and
enable display of the insight and the insight category in association with the communication item through a user experience associated with the communication service.

2. The computing device of claim 1, wherein the insight includes one of “reply”, “ping”, and “read”.

3. The computing device of claim 1, wherein the insight category includes one of “needed”, “recommended”, and “possible”.

4. The computing device of claim 1, wherein the one or more attributes of the communication item include a sender, one or more recipients, key words in a subject, a number of key words in the subject, a size of the subject, key words in a body, a number of key words in the body, a size of the body, and a number of attachments.

5. The computing device of claim 1, wherein the communication item includes one or more of an e-mail message, an appointment, a task, a voicemail, and an electronic event.

6. The computing device of claim 1, wherein if the communication item is a received communication item, one of a “reply” insight and a “read” insight is determined.

7. The computing device of claim 1, wherein if the communication item is a sent communication item with a first attribute associated with an age of the sent communication item and a second attribute associated with whether the sent communication item was responded to by one or more recipients, a “ping” insight is displayed.

8. A method executed at least in part on a computing device to provide a communication item insight, the method comprising:
determining one or more attributes of a communication item associated with a user;
determining an insight for the communication item based on a history of past communication items associated with the user comprising similar attributes to the determined one or more attributes, wherein:
if the communication item is a received communication item, one of a “reply” insight and a “read” insight is determined, and
if the communication item is a sent communication item with a first attribute associated with an age of the sent communication item and a second attribute associated with whether the sent communication item was responded to by one or more recipients, a “ping” insight is determined;
determining an insight category based on a level of confidence that the communication item corresponds to the insight; and
enabling display of the insight and the insight category in association with the communication item through a communication service user experience.

9. The method of claim 8, further comprising:
receiving a user request to determine the insight for the communication item through the communication service user experience, wherein the user request includes an insight and at least one of a time period and a communication item.

10. The method of claim 8, wherein determining the insight for the communication item based on the history of past communication items comprises:
determining one or more attributes and one or more user actions associated with the past communication items, wherein the one or more user actions inform an insight;
determining an expected value associated with the insight based on the determined one or more attributes of the past communication items; and
generating a model based on the insight and the expected value, wherein a separate model is generated for the “read” insight, the “reply” insight, and the “ping” insight.

11. The method of claim 10, further comprising:
applying the model to the determined one or more attributes of the communication item to determine the insight for the communication item.

12. The method of claim 10, further comprising:
re-generating the model periodically to adapt to current patterns of user actions.

13. The method of claim 10, further comprising:
persisting the model with a same entity configured to execute a communication service.

14. The method of claim 8, wherein determining the insight category based on the level of confidence that the communication item corresponds to the insight further comprises:
determining a probability of the communication item corresponding to the insight based on an applied model.

15. The method of claim 14, further comprising:
defining one or more thresholds in association with the probability in order to determine the level of confidence.

16. The method of claim 8, further comprising:
configuring at least one of the one or more attributes of the communication item into a reduced attribute format by:
adding values of the at least one attribute to a frequency histogram;
tagging frequently occurring values of the at least one attribute of the communication item; and
generating the reduced attribute format based on a number of occurrences of the tagged values of the at least one attribute of the communication item.

17. A computer readable memory device with instructions stored thereon to provide a communication item insight, the instructions comprising:
determining one or more attributes of a communication item that comprises one of an e-mail message, an appointment, a task, a voicemail, and an electronic event associated with a user;
determining an insight for the communication item based on a history of past communication items associated with the user comprising similar attributes to the determined one or more attributes;
determining an insight category based on a level of confidence that the communication item corresponds to the insight; and
enabling display of the insight and the insight category in association with the communication item through a communication service user experience.

18. The computer readable memory device of claim 17, wherein the instructions further comprise:
if the communication item is a communication item to be sent, providing one or more suggestions based on the determined insight to a sender of the communication item through the communication service user experience, wherein implementation of the one or more suggestions increase a probability that one or more recipients of the communication item at least one of read and reply to the communication item.

19. The computer readable memory device of claim 17, wherein the instructions further comprise:
enabling removal of the insight and the insight category for the communication item from display in response to a determination that an action associated with the insight has been completed.

20. The computer readable memory device of claim 17, wherein the instructions further comprise:
grouping the communication item with one or more other communication items with a same insight and insight category for display through the communication service user experience.
